(19) United States
(12) Patent Application Publication
(10) Pub. No.: US 2024/0356364 A1
(43) Pub. Date: Oct. 24, 2024

(54) CHARGING DEVICE FOR WEARABLE DEVICE AND WEARABLE DEVICE ASSEMBLY

(71) Applicant: HARMAN INTERNATIONAL INDUSTRIES, INCORPORATED, Stamford, CT (US)

(72) Inventors: Tieyi LIANG, Shenzhen, Guangdong (CN); Yi ZHANG, Shenzhen, Guangdong (CN); Bin CAI, Shenzhen, Guangdong (CN)

(21) Appl. No.: 18/681,474

(22) PCT Filed: Aug. 3, 2021
(86) PCT No.: PCT/CN2021/110312

§ 371 Date: Feb. 5, 2024

(51) Int. Cl. H02J 7/34; H04R 1/10

(52) U.S. Cl. CPC H02J 7/342; H04R 1/1025; H02J 2207/20

(57) ABSTRACT

A charging device for wearable device and wearable device assembly is provided. The charging device comprises: a power source module; a controller that is in communication with the power source module; a switch charger electrically connected to the power source module and adapted to receive a voltage output from the power source module and provide a voltage output to charge a battery in the wearable device via a power connection between the charging device and the wearable device. The wearable device assembly comprises: a charging device; a wearable device comprising a battery, wherein the charging device is adapted to charge the battery of the wearable device via a power connection between the charging device and the wearable device.

### TECHNICAL FIELD

This disclosure relates in general to a charging device for a wearable device and a wearable device assembly comprising a charging device and a wearable device, and particularly relates to a charging case for earbuds and an earbud assembly comprising a charging case and a pair of earbuds.

### BACKGROUND

In recent years, wireless earbuds, especially TWS (True Wireless Stereo) earbuds, have become more and more popular. When not in use, wireless earbuds, especially TWS earbuds which have no connecting wire between the earbuds, are usually stowed in a charging case, which can hold and charge the earbuds stowed therein.

As compared to wired earbuds, each of the wireless earbuds has a battery therein, which potentially increases the size and weight of the wireless earbuds. Accordingly, there is always a need for wireless earbuds having a smaller size and/or weight.

Nowadays, comfort joins battery life as the very important TWS purchase driver, reflecting a growing trend towards longer period of wireless listening time as well as reduced size and/or weight of the earbuds and charging case.

When charging the earbuds stowed therein, normally the charging case first boosts a voltage from a battery in the charging case to a 5V or 4.8V voltage by using a booster IC, and then supplies the 5V or 4.8V voltage to the earbuds. A linear charger positioned in the earbuds receives the 5V or 4.8V voltage from the charging case, and regulates a voltage drop between the 5V or 4.8V voltage and a battery in the earbud by inserting a resistive device to keep load voltage stable. The amount of energy loss of the linear charger is equal to the voltage drop multiplied by the current. The total charging efficiency is typically 70% or less, which may be low and undesirable.

When the charging efficiency is low, a bigger battery may be needed in the charging case, and extra heat will be generated due to the low charging efficiency. The extra heat generation may shorten the life of the batteries in both the case and the earbuds, and cause discomfort to users. Accordingly, there is a need for higher charging efficiency in order to maximize life and usage of the earbuds, while keeping a size of the battery in the charging case as small as possible.

### SUMMARY OF THE INVENTION

According to one aspect of the disclosure, a charging device for a wearable device is provided, the charging device comprising: a power source module; a controller that is in communication with the power source module; and a switch charger electrically connected to the power source module and adapted to receive a voltage output from the power source module and provide a voltage output to charge a battery in the wearable device via a power connection between the charging device and the wearable device.

According to another aspect of the disclosure, a wearable device assembly is provided, the wearable device assembly comprising: a charging device; and a wearable device comprising a battery, wherein the charging device is adapted to charge the battery of the wearable device via a power connection between the charging device and the wearable device.

Others systems, method, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the drawings are not necessarily to scale, emphasis instead being placed upon illustrating the principles of the disclosure. Moreover, in the figures, like reference numerals designate corresponding parts throughout the different views.

FIG. 1 is a block diagram of an earbud assembly according to one or more embodiments of the present disclosure;

FIG. 2 is a block diagram of an earbud assembly according to one or more further embodiments of the present disclosure;

FIG. 3 shows a perspective view of an earbud assembly according to one or more further embodiments of the present disclosure;

FIG. 4 is a perspective view showing an earbud assembly according to one or more embodiments of the present disclosure;

FIG. 5 is a block diagram of a wearable device assembly according to one or more embodiments of the disclosure;

FIG. 6 shows a charging curve of a battery, such as a Lithium Ion battery.

### BRIEF DESCRIPTION OF THE PREFERRED EMBODIMENTS

Hereinafter, several embodiments of the present disclosure will be described in more detail with reference to the accompanying drawings.

As used herein, the singular forms “a”, “an” and “the” are intended to include the plural forms as well, unless the context clearly indicates otherwise. The terms “comprises”, “comprising”, “includes” and/or “including”, as used herein, specify the presence of stated features, integers, steps, operations, elements, and/or components, but do not preclude the presence or addition of one or more other features, integers, steps, operations, elements, components, and/or groups thereof. As used herein, the term “and/or” and the symbol “/” are meant to include any and all combinations of one or more of the associated listed items. Additionally, while the terms first, second etc. may be used herein to describe various elements, components, steps or calculations, these elements, components, steps or calculations should not be limited by these terms, rather these terms are only used to distinguish one element, component, step or calculation from another. For example, a first component could be termed a second component, similarly a first calculation could be termed a second calculation; similarly a first step could be termed a second step: all without departing from the scope of this disclosure.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

As used herein, the term “charging IC” refers to an IC for charging a battery, such as a Lithium Ion battery. There are three types of charging IC, i.e., switch chargers, linear chargers and pulse chargers. A linear charger is a kind of charger that receives a voltage higher than that of the battery to be charged, and regulates the voltage drop between the received voltage and the battery to keep a load voltage/current to the battery stable, e.g., by inserting a resistive device. The linear charger has a main advantage of a small size and a main disadvantage of power dissipation. A switch charger is a kind of charger that provides a variable voltage output by using a switch-mode PWM regulation with the help of an inductor or LC filter. The switch charger has a main advantage of consistently low power dissipation over wide variations in input and battery voltage. The switch charger also has a main disadvantage of relatively large size due to its LC filter. In the prior art, an earbud normally has a linear charger therein for charging the battery due to the size restriction of the earbud.

A charging curve for a battery, such as a Lithium Ion battery, has a constant current (CC) phase, followed by a constant voltage (CV) phase. FIG. 6 shows an exemplary charging curve of a Lithium Ion battery. As shown in FIG. 6, in the CC phase, the battery voltage may range from about 3V to about 4.2V while in the CV phase, the battery voltage may be substantially maintained at about 4.2V. In a prior art earbud assembly where a voltage from a battery in the charging case may first be boosted to 5V by a DC-DC converter and then the boosted 5V voltage is supplied to charge an earbud battery via a linear charger in the earbud, the efficiency for boosting the battery voltage to 5V may be about 90% and the efficiency for a 5V voltage to charge the battery may be equal to a ratio of the battery voltage of the earbud to the 5V voltage. For example, the charging efficiency for a 5V voltage to charge the battery by using a linear charger may range from about 3/5 (when the battery voltage is about 3 V) to about 4.2/5 (when the battery voltage is about 4.2 V) in the CC phase and the charging efficiency may be about 4.2/5 in the CV phase (assuming the battery voltage is about 4.2 V). Thus, the total charging efficiency of the prior art charging may range from 54% (=90%*3/5) to 75.6% (=90%*4.2/5), which may be low and undesirable.

The present disclosure provides for a wearable device assembly comprising a wearable device and a charging device for the wearable device, e.g., an earbud assembly comprising a charging case and a pair of earbuds. The charging case comprises a power source module; a controller that is in communication with the power source module; and a switch charger electrically connected to the power source module and adapted to receive a voltage output from the power source module and provide a voltage output to charge a battery in the wearable device via a power connection between the charging device and the wearable device.

Since the switch charger for the battery of the earbud is provided in the charging case, there is no charging IC, i.e., no switch charger, no linear charger or no pulse charger, in the earbuds, and thus the earbuds may be more compact, have a smaller weight, or may have a larger battery without increasing the size or weight of the earbuds. As known in the art, a switch charger has a consistently low power dissipation over wide variations in input and battery voltage. Thus, the charging case or earbud assembly of the present disclosure may have an increased charging efficiency. Moreover, since the switch charger is provided in the charging case, the controller in the charging case may be in communication with the switch charger and thus may obtain the status of the switch charger in real time. Therefore, the controller in the charging case may control the charging process of the switch charging in a timely manner.

In one or more embodiments of the present disclosure, the earbud comprises a switch positioned between the contact VBUS and the protection IC for the battery. The controller of the earbud may be in communication with the switch and configured to place the switch in an open position to suspend the charging when the temperature of the battery of the earbud is too high.

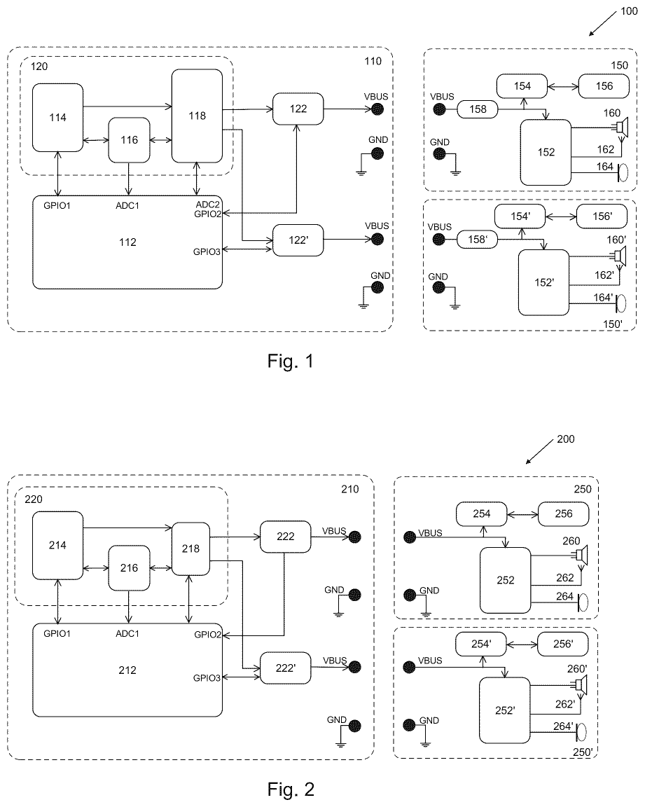

FIG. 1 is a block diagram of an earbud assembly 100 according to one or more embodiments of the present disclosure. The earbud assembly 100 comprises a charging case 110 and a pair of earbuds 150, 150′. The pair of the earbuds 150, 150′ may be stowed in the charging case 110 when not in use. As shown, the charging case 110 comprises a controller 112, a power source module 120, and a pair of buck switch chargers 122, 122′, and two sets of contacts each comprising two contacts VBUS and GND. The power source module 120 comprises a charger element 114, a battery 116 and a DC-DC converter 118. The earbud 150 comprises a controller 152, a protection IC 154, a battery 156, a switch 158, a speaker 160 and an antenna 162, a microphone 164, and two contacts, i.e., VBUS and GND. The earbud 150′ comprises a controller 152′, a protection IC 154′, a battery 156′, a switch 158′, a speaker 160′ and an antenna 162′, a microphone 164′, and two contacts, i.e., VBUS and GND. When the earbud 150 is stowed in the charging case 110, each of the contacts VBUS and GND of the earbuds 150 is in contact with and thus electrically connected to a corresponding contact in the first set of contacts VBUS and GND of the charging case 110 and thus a power line or power connection between the charging case 110 and the earbud 150 is established. The charging case 110 charges the earbud 150 via the power line or power connection. When the earbud 150′ is stowed in the charging case 110, each of the contacts VBUS and GND of the earbuds 150′ is in contact with and thus electrically connected to a corresponding contact in the second set of contacts VBUS and GND of the charging case 110 and thus a power line or power connection between the charging case 110 and the earbud 150′ is established. The charging case 110 charges the earbud 150′ via the power line or power connection.

The charger element 114 is electrically connected to the battery 116 and is configured to charge the battery 116 by using power supply from an external power source when the charging case 110 is connected to the external power source. The DC-DC converter 118 has two operating modes, i.e., a bypass mode and a boost mode. The DC-DC converter 118 operates in a bypass mode when the charging case 110 is electrically connected to an external power source, and operates in a boost mode when the charging case 110 is not electrically connected to an external power source. In the bypass mode of the DC-DC converter 118, the voltage output from the charger element 114 bypasses the DC-DC converter 118 and is supplied to the buck switch chargers 122, 122′ directly. That is, the voltage output from the charger element 114 bypasses the internal converter IC of the DC-DC converter 118 and is supplied to the buck switch charger 122, 122′ without its voltage being changed by the DC-DC converter. In the boost mode of the DC-DC converter 118, the DC-DC converter 118 is electrically connected to the battery 116, and is adapted to receive power supply from the battery 116 and boost the voltage output from the battery 116 to a stable voltage output, such as a 5V or 4.8V output. Each of the buck switch chargers 122, 122′ is electrically connected to the DC-DC converter 118 and is adapted to receive the voltage output from the DC-DC converter 118. The buck switch charger 122 is configured to provide a voltage to charge the battery 156 in the earbud 150 via a power line or connection between the charging case 110 and the earbud 150. The power line or connection is established when the earbud 150 is stowed in the charging case 110. The buck switch charger 122′ is configured to provide voltage to charge the battery 156′ in the earbud 150′ via a power line or connection between the charging case 110 and the earbud 150′.

The power line or connection is established when the earbud 150′ is stowed in the charging case 110. Each of the buck switch chargers 122, 122′ is configured to receive a voltage higher than that of the battery 156,156′ to be charged, and regulates the voltage drop between the received voltage and the battery 156,156′ to keep a load voltage/current to the battery 156,156′ stable. In one or more embodiments of the present disclosure, the controller 112 may communicate with the controller 352, 352′ via the power line or connection.

As shown, the controller 112 is adapted to be in communication with the charger element 114, the battery 116, the DC-DC converter 118 and the buck switch charger 122. During operation, the controller 112 is adapted to obtain a status of the battery 116 and receive input from the buck switch charger 122.

In the one or more embodiments shown in FIG. 1, the buck switch charger 122′, the second set of contacts VBUS, GND of the charging case 110, the earbud 150′ may be similar to the buck switch charger 122, the first set of contacts VBUS, GND of the charging case 110, the earbud 150, and thus detailed description therefor is omitted.

In the embodiments shown in FIG. 1, the DC-DC converter 118 has two operating modes, i.e., a bypass mode and a boost mode. However, the present disclosure is not limited thereto. In one or more embodiments of the present disclosure, the DC-DC converter may have only one operating mode, i.e., a boost mode. In the embodiments shown in FIG. 1, there is a switch 158, 158′ in the earbud 250, 252. However, the present disclosure is not limited thereto. In one or more embodiments of the present disclosure, the switch 158, 158′ may be omitted.

In the embodiment shown in FIG. 1, the DC-DC converter is a booster regulator, which is adapted to boost the battery voltage so as to provide a stable voltage output, such as a 5V or 4.8 V output. The efficiency for boosting the battery voltage to 5V may be about 90%. The efficiency for a switch charger to charge the battery in the earbuds may be about 90%. Thus, the total efficiency for the charging case of the present disclosure may be about 81%, which is significantly higher than the existing charging case in the prior art.

FIG. 2 is a block diagram of an earbud assembly 200 according to one or more further embodiments of the present disclosure. The earbud assembly 200 comprises a charging case 210 and a pair of earbuds 250, 250′. The pair of the earbuds 250, 250′ may be stowed in the charging case 210 when not in use. As shown, the charging case 210 comprises a controller 212, a power source module 220, a pair of buck-boost switch chargers 222, 222′, and two sets of contacts each comprising two contacts VBUS, GND. The power source module 220 comprises a charger element 214, a battery 216 and a switching device 218. The earbud 250 comprises a controller 252, a protection IC 254, a battery 256, a speaker 260 and an antenna 262, a microphone 264, and two contacts, i.e., VBUS, GND. The earbud 250′ comprises a controller 252′, a protection IC 254′, a battery 256′, a speaker 260′ and an antenna 262′, a microphone 264′, and two contacts, i.e., VBUS, GND. The embodiments shown in FIG. 2 is similar to those shown in FIG. 1, except that the switching device 218, the pair of buck-boost switch chargers 222, 222′ and there is no switch positioned between the contact VBUS and the protection IC 254, 254′ in the earbuds 250, 250′. The controller 212 communicates with the switching device 218, and the switching device 218 operates so that the buck-boost switch charger 222, 222′ may be electrically connected to the charger element 214 and receives input from the charger element 214 when the charging case is electrically connected to an external power source, and the buck-boost switch charger 222, 222′ may be electrically connected to the battery 216 and receives input from the battery 216 when the charging case is not electrically connected to an external power source. The buck-boost switch charger 222, 222′ may have a buck mode or a boost mode. In one or more embodiments of the present disclosure, the buck-boost switch charger 222, 222′ may operate in a buck mode when its input voltage is higher than earbud battery voltage plus 500 mv, and the buck-boost switch charger 222, 222′ may operate in a boost mode when its input voltage is equal to or lower than earbud battery voltage plus 500 mv. In one or more embodiments of the present disclosure, the buck-boost switch charger 222, 222′ may be Model SC8906 that is commercially available from SOUTHCHIP SEMICONDUCTOR.

In the embodiment shown in FIG. 2, the efficiency for the buck-boost switch charger to charge the battery in the earbuds may be about 88% at light load, such as at 20-30 mA current. Thus, the total efficiency for the charging case of the present disclosure may be about 88%, which is significantly higher than the existing charging case in the prior art.

In the embodiments shown in FIG. 2, there is a switching device 218 in the charging case. However, the present disclosure is not limited thereto and in one or more embodiments of the present disclosure, the switching device 218 may be omitted and the switch chargers 222, 222′ may be electrically connected to the battery 216 and may not be electrically connected to the charger element 214. In the embodiments shown in FIG. 2, there is no switch between the contact VBUS and the protection IC 254, 254′ in the earbuds 250, 250′. However, the present disclosure is not limited thereto and the in one or more embodiments of the present disclosure, there may be a switch provided between the contact VBUS and the protection IC 254, 254′ in the earbuds 250, 250′.

Other elements and operations of the embodiments shown in FIG. 2 are similar or the same to those of the embodiments shown in FIG. 1, and thus detailed description therefor is omitted.

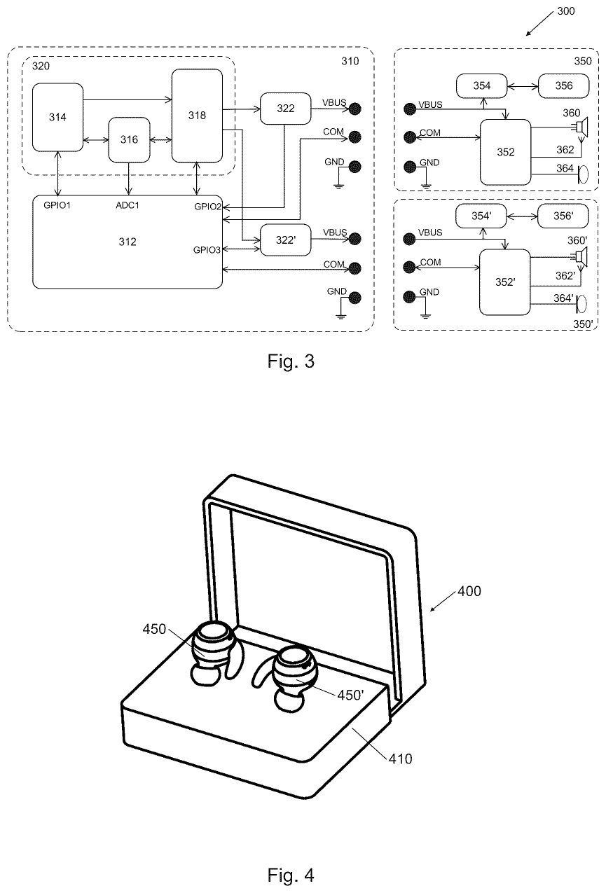

FIG. 3 is a block diagram of an earbud assembly 300 according to one or more embodiments of the present disclosure. The earbud assembly 300 comprises a charging case 310 and a pair of earbuds 350, 350′. The pair of the earbuds 350, 350′ may be stowed in the charging case 310 when not in use. As shown, the charging case 310 comprises a controller 312, a power source module 320, and a pair of buck switch chargers 322, 322′, and two sets of contacts each comprising three contacts VBUS, COM and GND. The power source module 320 comprises a charger element 314, a battery 316 and a DC-DC converter 318. The earbud 350 comprises a controller 352, a protection IC 354, a battery 356, a speaker 360 and an antenna 362, a microphone 364, and three contacts, i.e., VBUS, COM and GND. The earbud 350′ comprises a controller 352′, a protection IC 354′, a battery 356′, a speaker 360′, an antenna 362′ and a microphone 364′, and three contacts, i.e., VBUS, COM and GND.

The embodiments shown in FIG. 3 is similar to those shown in FIG. 1, except that in FIG. 3, the charging case 310 and the earbuds 350, 350′ includes an additional contact COM, and there is no switch device between the contact VBUS and the protection IC 354, 354′ in the earbuds 350, 350′. When the earbuds 350, 350′ are stowed in the charging case 310, a communication line or connection is established through the contact COM of the charging case 310 and the contact COM of the earbud 350, 350′. The controller 312 may communicates with the controller 352, 352′ through the communication line or connection to obtain information from the earbuds 350, 350′, such information regarding the status of the battery 356, 356′.

In the embodiments shown in FIG. 3, there is no switch device between the contact VBUS and the protection IC 354, 354′ in the earbuds 350, 350′. However, the present disclosure is not limited thereto and the in one or more embodiments of the present disclosure, there may be a switch device provided between the contact VBUS and the protection IC 354, 354′ in the earbuds 350, 350′.

FIG. 4 shows a perspective view of an earbud assembly 400 according to one or more embodiments of the present disclosure. The earbud assembly 400 comprises a charging case 410 and a pair of earbuds 450, 450′. The earbuds 450, 450′ may be stowed in the charging case 410 when not in use. The charging case and earbuds shown in FIG. 4 are merely illustrative, and the present disclosure is not limited thereto. In one or more other embodiments according to the present disclosure, the charging case and earbuds may have any suitable appearance, shape or configuration.

The present disclosure has been described in connection with charging cases for earbuds and earbud assemblies shown in FIGS. 1-4. However, the present disclosure is not limited to charging cases for earbuds and earbud assemblies. According to one or more embodiments, the present disclosure may apply to a wearable device assembly. The wearable device of the present disclosure may be, e.g., a smart watch, a smart bracelet, smart glasses.

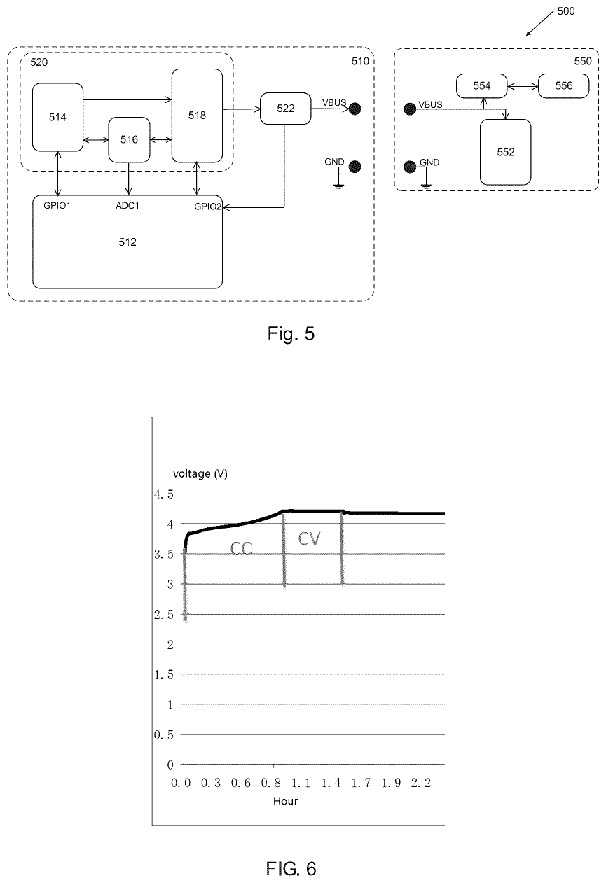

FIG. 5 is a block diagram of a wearable device assembly 500 according to one or more embodiments of the disclosure. The wearable device assembly 500 comprises a wearable device 550 and a charging device 510 for charging the wearable device 550. As shown, the charging device 510 comprises a controller 512, a power source module 520, a buck switch charger 522, and a set of contacts each comprising two contacts VBUS, GND. The power source module 520 may comprise a charger element 514, a battery 516 and a DC-DC converter 518. The wearable device 550 comprises a controller 552, a protection IC 554, a battery 556, and two contacts, i.e., VBUS, GND. When the charging device 510 is charging the wearable device 550, each of the contacts VBUS, GND of the earbuds 550 is in contact with and thus electrically connected to a corresponding contact in the contacts VBUS, GND of the charging device 510 and thus a power line or connection between the charging device 510 and the wearable device 550 is established. The charging device 510 may charge the wearable device 550 via the power line or connection.

Elements and operations of the embodiments shown in FIG. 5 may be similar or the same to those of the embodiments shown in FIG. 1, and thus detailed description therefor is omitted.

In the embodiments shown in FIG. 5, the wearable assembly comprises a charging device and one wearable device. However, the present disclosure is not limited thereto. In one or more other embodiments of the present disclosure, the wearable assembly may comprises more than one wearable device, such as two wearable devices or three wearable devices. FIG. 5 shows a specific configuration of a wearable assembly according to one or more embodiments of the present disclosure. However, the present disclosure is not limited thereto. In one or more further embodiments, the wearable assembly of the present disclosure may include the switching device and the buck-boost switch charger as shown in FIG. 2. In one or more further embodiments, the wearable assembly of the present disclosure may include a contact COM, as shown in FIG. 3. In one or more further embodiments, the wearable device of the present disclosure may include a switch positioned between the contact VBUS and the protection IC 554.

In the embodiments shown, the protection IC 154, 254, 354, 554 and the battery 156, 256, 356, 556 are separate elements. The present disclosure is not limited thereto, and in one or more other embodiments of the present disclosure, the protection IC 154, 254, 354, 554 and the battery 156, 256, 356, 556 may be integrated in one component. Similarly, the protection IC 154′, 254′, 354′ and the battery 156′, 256′, 356′ may be integrated in one component as well.

In one or more embodiments of the present disclosure, the boost regulator may be a High-Efficiency Boost Converter of Model MAX77813 that is commercially available from Maxim Integrated Products, Inc. However, the present disclosure is not limited thereto. Any suitable boost regulator or converter or DC-DC converter may be used in the present disclosure.

According to one or more embodiments of the disclosure, the present disclosure can be implemented as follows.

Item 1: a charging device for a wearable device, the charging device comprising: a power source module; a controller that is in communication with the power source module; a switch charger electrically connected to the power source module and adapted to receive a voltage output from the power source module and provide a voltage output to charge a battery in the wearable device via a power connection between the charging device and the wearable device.

Item 2: the charging device according to Item 1, wherein the power source module comprises: a battery; a charger element electrically connected to the battery, and adapted to charge the battery by using input from an external power source when the charging device is connected to the external power source; and a DC-DC converter electrically connected to the battery, and adapted to receive input from the battery and provide a voltage output, wherein the switch charger is a buck switch charger and is adapted to receive the voltage output from the DC-DC converter and provide a voltage output to charge the battery in the wearable device.

Item 3: the charging device according to any of Items 1-2, wherein the power source module comprises a battery and a charger element electrically connected to the battery and adapted to charge the battery by using input from an external power source when the charging device is connected to the external power source; wherein the switch charger is a buck-boost switch charger and is adapted to receive the voltage output from the battery and provide a voltage output to charge the battery in the wearable device.

Item 4: the charging device according to any of Items 1-3, wherein the charging device is a charging case for earbuds and the wearable device is a pair of earbuds.

Item 5: the charging device according to any of Items 1-4, wherein the switch charger comprises a first and second switch chargers.

Item 6: the charging device according to any of Items 1-5, wherein the first switch charger is electrically connected to the power source module and adapted to receive a first voltage output from the power source module and provide a voltage output to charge a first earbud of the pair of the earbuds, the second switch charger is electrically connected to the power source module and adapted to receive a second voltage output from the power source module and provide a voltage output to charge a second earbud of the pair of the earbuds.

Item 7: the charging device according to any of Items 1-6, wherein the first voltage output is independent from the second voltage output.

Item 8: the charging device according to any of Items 1-7, wherein the first voltage output is 0.2-0.3 V higher than the voltage of the battery in the first earbud, and the second voltage output is 0.2-0.3 V higher than the voltage of the battery in the second earbud.

Item 9: the charging device according to any of claims 1-8, wherein the power connection is established through an engagement between contacts of the charging case and contacts of the earbuds when the earbuds are stowed in the charging case.

Item 10: a wearable device assembly, comprising: a charging device according any of Items 1-9; a wearable device comprising a battery, wherein the charging device is adapted to charge the battery of the wearable device via a power connection between the charging device and the wearable device.

Item 11: the wearable device assembly according to Item 10, wherein the charging device is a charging case for earbuds, the wearable device is a pair of earbuds.

Item 12: the wearable device assembly according to any of Items 10-11, wherein there is no charging IC in the wearable device.

Systems and methods have been described in general terms as an aid to understanding details of the disclosure. In some instances, well-known structures, materials, and/or operations have not been specifically shown or described in detail to avoid obscuring aspects of the disclosure. In other instances, specific details have been given in order to provide a thorough understanding of the disclosure. One skilled in the relevant art will recognize that the disclosure may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the disclosure. Accordingly, the disclosure is not to be restricted except in light of the attached claims and their equivalents.

1. A charging device for a wearable device, the charging device comprising:
a power source module; and
a controller that is in communication with the power source module;
a switch charger electrically connected to the power source module and adapted to receive a voltage output from the power source module and provide a voltage output to charge a battery in the wearable device via a power connection between the charging device and the wearable device.

2. The charging device according to claim 1, wherein the power source module comprises
a battery;
a charger element electrically connected to the battery, and adapted to charge the battery by using input from an external power source when the charging device is connected to the external power source; and
a DC-DC converter electrically connected to the battery, and adapted to receive input from the battery and provide a voltage output from the DC-DC converter,
wherein the switch charger is a buck switch charger and is adapted to receive the voltage output from the DC-DC converter and provide a voltage output to charge the battery in the wearable device.

3. The charging device according to claim 1, wherein the power source module comprises a battery and a charger element electrically connected to the battery and adapted to charge the battery by using input from an external power source when the charging device is connected to the external power source; and
wherein the switch charger is a buck-boost switch charger and is adapted to receive the voltage output from the battery and provide a voltage output to charge the battery in the wearable device.

4. The charging device according to claim 1, wherein the charging device is a charging case for earbuds and the wearable device is a pair of earbuds.

5. The charging device according to claim 4, wherein the switch charger comprises a first switch charger and a second switch charger.

6. The charging device according to claim 5, wherein the first switch charger is electrically connected to the power source module and is adapted to receive a first voltage output from the power source module and provide a voltage output to charge a first earbud of the pair of the earbuds, and
the second switch charger is electrically connected to the power source module and is adapted to receive a second voltage output from the power source module and provide a voltage output to charge a second earbud of the pair of the earbuds.

7. The charging device according to claim 6, wherein the first voltage output is independent from the second voltage output.

8. The charging device according to claim 6, wherein the first voltage output is 0.2-0.3 V higher than a voltage of the battery in the first earbud, and the second voltage output is 0.2-0.3 V higher than a voltage of the battery in the second earbud.

9. The charging device according to claim 4, wherein the power connection between the charging device and the wearable device is established through an engagement between contacts of the charging case and contacts of the earbuds when the earbuds are stowed in the charging case.

10. A wearable device assembly, comprising:
the charging device according claim 1;
wherein the wearable device comprises a battery, and
wherein the charging device is adapted to charge the battery of the wearable device via the power connection between the charging device and the wearable device.

11. The wearable device assembly according to claim 10, wherein the charging device is a charging case for earbuds, and the wearable device is a pair of earbuds.

12. The wearable device assembly according to claim 10 wherein there is no charging IC in the wearable device.
